(19) United States
(12) Patent Application Publication
(10) Pub. No.: US 2011/0188910 A1
(43) Pub. Date: Aug. 4, 2011

(54) FIXING DEVICE AND IMAGE FORMING APPARATUS

(75) Inventors: Shinya NAKASHIMA, Kanagawa (JP); Shuji Sato, Kanagawa (JP); Masaru Takahashi, Kanagawa (JP)

(73) Assignee: FUJI XEROX CO., LTD., Tokyo (JP)

(21) Appl. No.: 12/858,780

(22) Filed: Aug. 18, 2010

(30) Foreign Application Priority Data
Feb. 1, 2010 (JP) 2010-020172

(51) Int. Cl. G03G 15/20

(52) U.S. Cl. 399/333

(57) ABSTRACT

A fixing device is configured to fix a toner image formed on a recording medium and includes a fixing roll, a separation claw in contact with the fixing roll, and a pressure member disposed to face the fixing roll. The fixing roll includes a metallic core and a surface layer formed on the metallic core. The surface layer is an electroless nickel plating layer containing a boron compound and a phosphorus compound.

### CROSS-REFERENCE TO RELATED APPLICATIONS

This application is based on and claims priority under 35 USC 119 from Japanese Patent Application No. 2010-020172 filed Feb. 1, 2010.

### BACKGROUND

(i) Technical Field

The present invention relates to a fixing device and an image forming apparatus.

(ii) Related Art

In general, a copying machine, a printer, a facsimile, or the like is provided with a fixing device that fixes unfixed toner to paper. In the fixing device, a fixing roll, a pressure roll that presses paper on the fixing roll, a separation claw (also referred to as a “stripping claw”) that separates paper from the fixing roll, and a thermistor that controls temperature are provided.

Such a fixing roll generally includes a metallic core made of a metal such as aluminum, iron, or the like, and a fluorocarbon resin layer provided as a release layer on the surface of the metallic core and made of PTFE (tetrafluoroethylene resin), PEA (tetrafluoroethylene/perfluoroalkyl vinyl ether copolymer), or the like.

### SUMMARY

According to an aspect of the invention, there is provided a fixing device configured to fix a toner image formed on a recording medium, the fixing device including a fixing roll, a separation claw in contact with the fixing roll, and a pressure member disposed so as to face the fixing roll. The fixing roll includes a metallic core and a surface layer formed on the metallic core. The surface layer is an electroless nickel plating layer containing a boron compound and a phosphorus compound.

### BRIEF DESCRIPTION OF THE DRAWINGS

Exemplary embodiments of the present invention will be described in detail based on the following figures, wherein:

FIG. 1 is a schematic drawing showing an example of an image forming apparatus according to an exemplary embodiment of the present invention;

FIG. 2 is a schematic drawing showing an example of a fixing device according to an exemplary embodiment of the present invention;

FIG. 3 is a perspective view showing an example of a fixing roll according to an exemplary embodiment of the present invention; and

FIG. 4 is a drawing illustrating a method for forming an electroless nickel plating layer on the surface of a metallic core.

### DETAILED DESCRIPTION

A fixing device according to an exemplary embodiment of the present invention is configured to fix a toner image formed on a recording medium and includes a fixing roll, a separation claw in contact with the fixing roll, and a pressure member disposed to face the fixing roll. The fixing roll includes a metallic core and a surface layer formed on the metallic core. The surface layer is an electroless nickel plating layer containing a boron compound and a phosphorus compound.

An image forming apparatus according to an exemplary embodiment of the present invention includes an image carrier, a charging unit that charges the image carrier, an exposure unit that exposes the charged image carrier to form an electrostatic latent image on the image carrier, a developing unit that develops the electrostatic latent image with a developer containing a toner to form a toner image, a transfer unit that transfers the toner image to a recording medium, and a fixing unit that fixes the toner image to the recording medium. The fixing unit is the above-described fixing device.

There are increasing demands for decreasing the cost and size of a copying machine or a printer using electrophotography. However, in designing such a copying machine or printer, it is desirable to fix a toner with low power consumption and simplify a fixing method. At present, a fixing method using a heat roll is most generally used as a method for melt-fixing the toner to paper. The heat roll is coated with a surface layer of a material having small surface energy, such as a fluorocarbon resin or the like, in order to prevent fusion of the toner to the roll during heat-fixing of the toner, and the roll surface material is limited. When the fixing roll is heated, the fluorocarbon resin may inhibit thermal conductivity, and thus the thickness of the fluorocarbon resin of the fixing roll surface layer is limited for the purpose of efficient thermal conduction. In addition, such a resin is worn or flawed during repeated use, and thus wettability of the fixing roll surface is not stably maintained over a long period of time. Therefore, it is desired to develop a fixing device and an image forming apparatus in which the surface of a fixing roll may not be coated with a fluorocarbon resin having small surface energy.

According to an exemplary embodiment of the present invention, an electroless nickel plating layer containing a boron compound and a phosphorus compound is used as a surface layer of a fixing roll, thereby forming a high-strength plating film. Thus, the occurrence of finger marks by a separation claw is suppressed over a long period without coating with a fluorocarbon resin or the like.

The separation claw is provided for separating a recording medium from the fixing roll and is provided in contact with the fixing roll. Flaws referred to as finger marks may occur on the fixing roll due to contact between the fixing roll and the separation claw. In particular, the occurrence of the finger marks tends to be promoted with increase in the fixing rate.

Further, wax and recording medium dust (e.g., paper dust) which leak out during fixing are easily accumulated in the finger marks. The accumulated substances may be transferred to a pressure member and the like after the recording medium is transported from a nip, thereby staining the back of the recording medium during subsequent printing. The staining on the back remarkably occurs in fixing of high TMA (Toner Mass Area) images.

That is, in a fixing device according to an exemplary embodiment of the present invention, the occurrence of finger marks is suppressed, and the occurrence of staining on the back of a recording medium is suppressed.

A fixing device and an image forming apparatus according to exemplary embodiments of the present invention are described in detail below with reference to the drawings. In a description below, a same reference numeral denotes a same member.

Unless otherwise specified, the expression “a lower limit to an upper limit” which indicates a numerical limitation represents “a lower limit or more and an upper limit or less”, and the expression “an upper limit to a lower limit” represents “a lower limit or less and an upper limit or more”. Namely, these expressions each represent a numerical range including an upper limit and a lower limit as end points.

### (Image Forming Apparatus and Fixing Device)

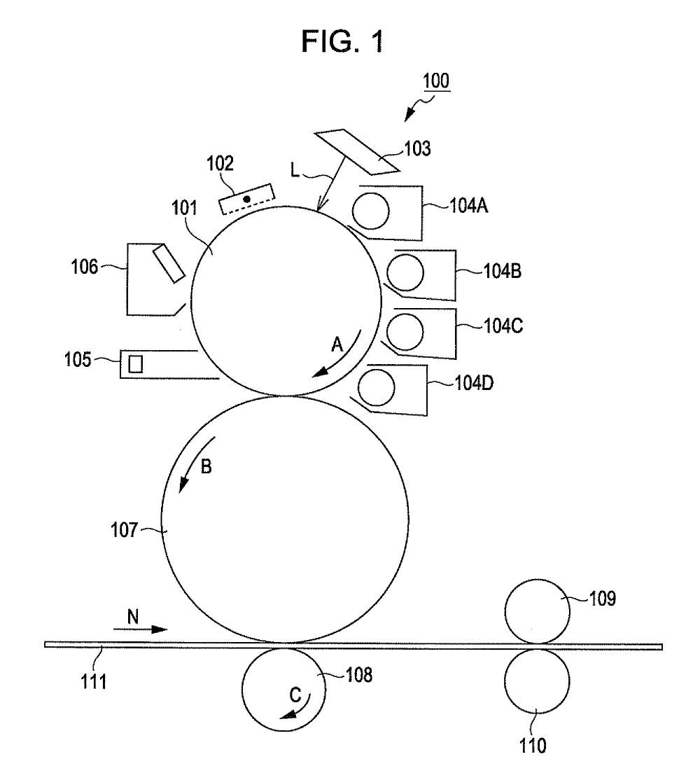

FIG. 1 is a schematic drawing showing an example of an image forming apparatus according to an exemplary embodiment of the present invention. An image forming apparatus 100 shown in FIG. 1 includes an image carrier 101, a charger (charging unit) 102, a writing unit 103 for forming an electrostatic latent image, developing units 104A, 104B, 1040, and 104D that contain developers of black (K), yellow (Y), magenta (M), and cyan (C), respectively, an erase lamp 105, a cleaning device 106, an intermediate transfer member 107, a transfer roll 108, a fixing roll 109, and a pressure roll (pressure member) 110.

Formation of an image using the image forming apparatus 100 is described. First, the surface of the image carrier 101 is uniformly charged with the non-contact charger 102 in association with rotation of the image carrier 101. The charged image carrier 101 is exposed to light L that is scan on the surface of the uniformly charged image carrier 101 by the writing unit 103, forming an electrostatic latent image corresponding to image information of each of the colors. Then, a toner is supplied to the surface of the image carrier 101, on which the electrostatic latent image has been formed, from the developing unit 104A, 104B, 104C, or 104D, thereby forming a toner image.

Next, when a voltage is applied between the image carrier 101 and the intermediate transfer member 107 from a power supply (not shown), the toner image formed on the surface of the image carrier 101 is transferred to the surface of the intermediate transfer member 107 in a contact portion between the image carrier 101 and the intermediate transfer member 107.

The charge of the surface of the image carrier 101 from which the toner image is transferred to the intermediate transfer member 107 is removed by irradiation with light from the erase lamp 105. Further, the toner remaining on the surface is removed by a cleaning blade of the cleaning device 106.

The above-described process is repeated for each of the colors to laminate toner images of the respective colors on the surface of the intermediate transfer member 107 according to image information.

In the above-described process, the transfer roll 108 that rotates in direction C is not in contact with the intermediate transfer member 107. The transfer roll 108 is brought into contact with the intermediate transfer member 107 during transfer to the recording medium 111 after the toner images of all colors are laminated on the surface of the intermediate transfer member 107.

The toner images laminated on the surface of the intermediate transfer member 107 as described above are moved to the contact portion between the intermediate transfer member 107 and the transfer roll 108 in association with rotation of the intermediate transfer member 107 in a direction of arrow B. At the same time, the recording medium 111 is passed through a contact portion with a paper transport roll (not shown) in a direction of arrow N. As a result, the toner images laminated on the surface of the intermediate transfer member 107 are transferred together to the surface of the recording medium 111 in the contact portion by the voltage applied between the intermediate transfer member 107 and the transfer roll 108.

The recording medium 111 with the toner images transferred to the surface thereof is transported to the fixing device including the fixing roll 109 and the pressure roll 110, and the toner images are fixed to the surface of the recording medium 111 to form an image.

Although the rotary image forming apparatus is described as an example above, this exemplary embodiment is not limited to this and, of course, may be applied to a tandem image forming apparatus in a similar manner.

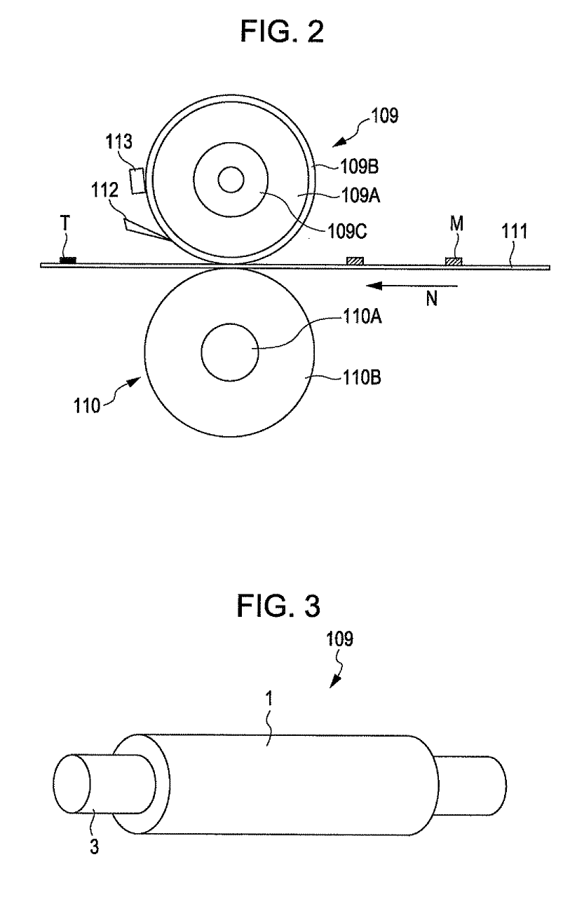

Next, the fixing device is described in further detail. FIG. 2 is a schematic drawing showing an example of the fixing device according to the exemplary embodiment of the present invention.

The fixing device shown in FIG. 2 includes the fixing roll 109 including a metallic core 109A, a surface layer 109B, and a heat source (halogen lamp) 109C, the pressure roll 110 including a metallic core 110A and an elastic layer 110B, and a temperature sensor 113. The fixing roll 109 and the pressure roll 110 are put in pressure contact to form a nip. The fixing device also includes a separation claw 112 that separates the recording medium from the fixing roll 109.

As described above, when the recording medium 111 with an unfixed toner image M formed thereon is transported to the nip in a direction of arrow N and passed through the nip, the recording medium 111 is heated with the fixing roll 109 having a surface heated by the built-in heating source 109C to form a fixed toner image T on the recording medium 111.

In the fixing device shown in FIG. 2, the fixing roll 109 has, as a surface layer, a nickel plating layer containing a boron compound and a phosphorus compound, thereby causing excellent friction resistance and suppressing the occurrence of finger marks due to the separation claw 112 over a long time.

### (Fixing Roll)

Next, the fixing roll used in the exemplary embodiment is described.

FIG. 3 is a perspective drawing showing an example of the fixing roll used in this exemplary embodiment.

The fixing roll 109 shown in FIG. 3 includes a surface layer 1 formed on a metallic core 3. The surface layer 1 is an electroless nickel plating layer containing a boron compound and a phosphorus compound. The metallic core 3 has a substantially cylindrical shape.

The metallic core 3 is appropriately selected from general known metallic cores, such as metallic cores made of stainless steel, iron, aluminum, and the like.

### <Surface Layer>

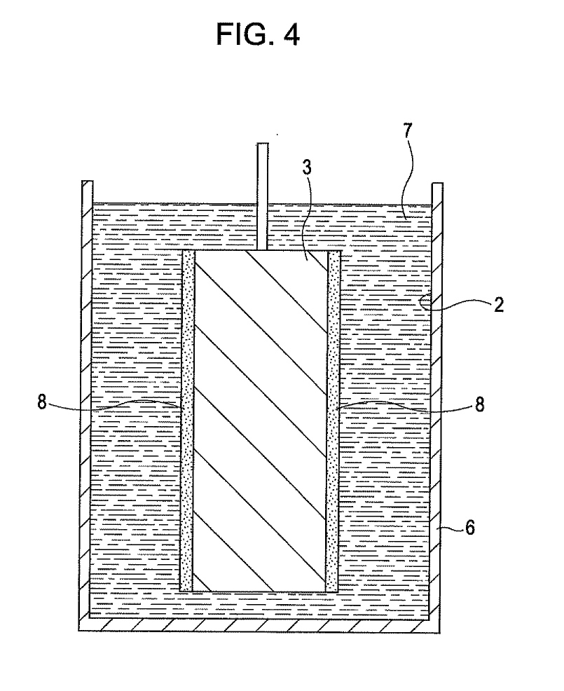

The surface layer 1 of the fixing roll according to the exemplary embodiment is produced by an electroless nickel plating method described below. FIG. 4 is a drawing showing a method for forming an electroless nickel plating layer on the surface of a metallic core. As shown in FIG. 4, the substantially cylindrical metallic core 3 is immersed in a plating bath 6 filled with an electroless nickel plating solution 7 containing a boron compound and a phosphorus compound. Consequently, as shown in FIG. 4, a nickel film 8 containing a born compound and a phosphorus compound is deposited by autocatalysis on the surface of the metallic core 3.

The film 8 is grown on the surface of the metallic core 3 as described above and the metallic core 3 is pulled up from the plating bath 6 at a stage in which a desired thickness is obtained.

In electroless plating, plating metal ions are deposited by reduction with electrons that are emitted by oxidation of a reducing agent on a metal surface having catalytic activity. Once a metal is deposited, reaction is continued by autocatalysis of the deposited metal, continuously forming a plating film.

There is a technique for forming multifunctional plating films by dispersing various types of functional fine particles in plating films. The fine particles may inhibit close packing of plating metal particles, resulting in a decrease in strength of the plating films. A plating film containing functional fine particles dispersed therein is described in Japanese Unexamined Patent Application Publication No. 2006-276303.

The strength of an electroless plating film depends on uniformity of a primary plating metal layer formed by a first reductive reaction. Therefore, a reductive reaction sufficient to form a uniform primary plating layer is induced by using a phosphorus compound and a boron compound having high reducing power in combination. As a result, a high-strength plating film is formed.

Electroless nickel plating according to the exemplary embodiment is performed using, as a nickel supply source, an inorganic acid or organic acid nickel salt such as nickel sulfate, nickel hydrochloride, nickel carbonate, nickel acetate, or the like. The plating bath is prepared by dissolving such a nickel salt in water at a nickel concentration of preferably 0.05 to 2.0 mol/L, more preferably 0.8 to 1.2 mol/L, and adding a born compound and a phosphorus compound as a reducing agent, and, if required, various additives to the resultant solution.

The exemplary embodiment uses the nickel plating bath containing a boron compound. The boron compound used for forming the electroless nickel plating layer is not particularly limited as long as it has reactivity sufficient as a reducing agent and is appropriately selected from boron compounds generally known as reducing agents.

Specific examples of the boron compound include (dimethylamino)boron, (diethylamino)boron, sodium borohydride, potassium borohydride, lithium borohydride, and the like. Among these, (dimethylamino)boron is preferred.

These boron compounds may be used alone or used in combination of two or more.

The content of the boron compound in the plating bath is preferably about 0.1 to 100 mmol/L, more preferably about 0.5 to 50 mmol/L, and most preferably about 1 to 10 mmol/L. With the boron compound at a content within this range, a high-strength plating film may be formed. When two or more boron compounds are used, a total content is adjusted to the above value.

The boron compound contained in the electroless nickel plating layer formed by electroless plating is detected by the following method. Specifically, the fixing roll cut into a size of 10×10 mm is subjected to ion etching for 180 seconds under the conditions including an Ar atmosphere, an acceleration voltage of 400 V, and a vacuum degree of 3×10⁻² Pa and then X-ray photoelectron spectrometry (XPS) for detecting boron elements under the conditions including an acceleration voltage of 20 kV and a current of 10 mA.

The exemplary embodiment uses the nickel plating bath containing, as a reducing agent, a phosphorus compound in addition to the boron compound. The phosphorus compound used for forming the electroless nickel plating layer is not particularly limited as long as it has reactivity sufficient as a reducing agent and is appropriately selected from phosphorus compounds generally known as reducing agents.

Specific examples of the phosphorus compound include hypophosphorus acid alkali metal salts such as sodium hypophosphite, potassium hypophosphite, and the like; nickel hypophosphite; and the like.

These phosphorus compounds may be used alone or used in combination of two or more.

The content of the phosphorus compound in the plating bath is preferably about 0.01 to 10 mmol/L, more preferably about 0.05 to 5 mmol/L, and most preferably about 0.1 to 1 mmol/L. With the phosphorus compound at a content within this range, a high-strength plating film may be formed. When two or more phosphorus compounds are used, a total content is adjusted to the above value.

The phosphorus compound contained in the electroless nickel plating layer formed by electroless plating is detected by the following method. Specifically, the fixing roll cut into a size of 10×10 mm is subjected to ion etching for 180 seconds under the conditions including an Ar atmosphere, an acceleration voltage of 400 V, and a vacuum degree of 3×10⁻² Pa and then X-ray photoelectron spectrometry (XPS) for detecting phosphorus elements under the conditions including an acceleration voltage of 20 kV and a current of 10 mA.

In this exemplary embodiment, the plating film is formed by electroless nickel plating preferably at a plating bath temperature of about 60° C. to 95° C. and more preferably about 70° C. to 90° C. At a plating bath temperature of about 60° C. or more, the deposition rate of the plating film is desirably increased. At a plating bath temperature of about 95° C. or less, the amount of water evaporated is desirably decreased, thereby decreasing the supply of water.

In this exemplary embodiment, the pH of the plating solution is, but is not limited to, preferably about 4.5 to 7.5 and more preferably about 5.0 to 6.5. With pH within this range, a reverse reaction phenomenon that deposited nickel becomes nickel ions by oxidation is desirably suppressed.

In this exemplary embodiment, the plating solution may contains various additives in combination with the above-described reducing agent. Examples of the additives include a pH adjustor, a pH buffer, a complexing agent, an accelerator, a modifier, and the like.

Examples of the pH adjustor include basic materials such as alkali metal hydroxides, carbonates, ammonia, and the like; and acid materials such as sulfuric acid, acetic acid, and the like.

Examples of the pH buffer include organic acids such as acetic acid, butyric acid, oxalic acid, succinic acid, glycolic acid, and the like; and alkali metal salts thereof.

The complexing agent is added for preventing precipitation of a reaction product in the plating solution. Examples of the complexing agent include O-coordination compounds such as glycolic acid, lactic acid, succinic acid, tartaric acid, and the like; S-coordination compound such as thioglycolic acid, cysteine, and the like; and N-coordination compounds such as ammonia, hydrazine, triethanolamine, glycine, and the like.

The accelerator is a reaction accelerator that increases a plating rate to some extent. Examples of the accelerator includes sulfides such as thiourea, thioglycolic acid, and the like.

Examples of the modifier include a brightener that imparts gloss to the plating film, a wetting agent that improves wettability with a base material, and the like, and various surfactants may be used as the modifier.

In this exemplary embodiment, the plating solution may contain resin particles having low surface energy, such as fluorocarbon resin particles.

Specific examples of a resin of the fluorocarbon resin particles include PTFE (tetrafluoroethylene resin), PFA (tetrafluoroethylene/perfluoroalkyl vinyl ether copolymer), FEP (tetrafluoroethylene/hexafluoropropylene copolymer), ETFE (polyethylene/tetrafluoroethylene copolymer), PVDF (polyvinylidene fluoride), PCTFE (polychlorotrifluoroethylene), PVF (vinyl fluoride), and the like.

The content of the fluorocarbon resin particles in the plating film is preferably about 30% by weight or less, more preferably about 20% by weight or less, and most preferably 10% by weight or less. From the viewpoint of enhancing the fraction resistance of the surface layer, as described above it is desirable that the fluorocarbon resin particles are not contained.

The thickness of the surface layer (electroless nickel plating layer) s preferably about 5 to 30 μm and more preferably about 5 to 20 μm from the viewpoint of durability sufficient for the fixing member and heat conductivity to the recording medium.

### (Toner)

In the fixing device according to this exemplary embodiment, a toner satisfying the conditions below is used from the viewpoint of improving release properties.

It is desirable to use a toner having a storage modulus G′ (140° C.) of about 8.0×10³ dN/m² or more and about 2.0×10⁴ dN/m² or less at about 140° C. and a frequency of about 1 Hz, and a dynamic loss tangent (tan δ=G″/G′) of about 0.2 or more and about 0.4 or less that is a ratio of loss modulus G″ to storage modulus G′ at 140° C.

The heat energy applied during fixing is partially absorbed by paper, not entirely used for melting the toner. As a result of verification, the inventors of the present invention have found that about 80% of the heat energy supplied from a fixing device is used for melting a toner. Therefore, viscoelasticity of the toner at 140° C. is specified.

Here, elasticity (storage modulus G′) for preventing offset, viscosity (loss modulus G″) for fusion to paper, and balance between two moduli (tan δ=G″/G′) are specified as the viscoelasticity of the toner.

When the storage modulus G′ (140° C.) of the toner at about 140° C. and a frequency of about 1 Hz is about 8.0×10³ dN/m² or more, sufficient toner cohesive force is achieved, thereby suppressing the occurrence of offset and wax offset due to excessive leaking of a low-melting-point component such as a release agent or the like. When the storage modulus G′ (140° C.) is about 2.0×10⁴ dN/m² or less, excellent fusion between toner particles or between the toner and the recording medium is achieved, thereby causing high image strength.

The storage modulus G′ (140° C.) is more preferably about 8.0×10³ dN/m² to about 1.5×10⁴ dN/m², and most preferably about 8.5×10³ dN/m² to about 1.0×10⁴ dN/m².

When the dynamic loss tangent (tan δ=G″/G′) is about 0.2 or more, excellent adhesion between the toner and the recording medium is desirably exhibited, thereby achieving satisfactory image strength. In addition, when the dynamic loss tangent (tan δ=G″/G′) is about 0.4 or less, satisfactory cohesive force between toner particles is desirably exhibited, thereby suppressing the occurrence of offset.

The dynamic loss tangent (tan δ=G″/G′) is more preferably about 0.25 to 0.4 and most preferably about 0.27 to 0.38.

The storage modulus G′ and the loss modulus G″ are measured using, for example, a rotary plate-type rheometer (TA Instruments Co., Ltd., ARES). In this exemplary embodiment, temperature rise measurement is performed at a frequency of about 1 Hz using a rheometer (Rheometric Scientific Inc., ARES Rheometer) and parallel plates having a diameter of 8 mm. A sample is set at 140° C. with a zero-point adjustment temperature of 90° C. and an inter-plate gap of 3.5 mm, cooled to room temperature, and then heated at a heating rate of about 1° C./min from a measurement start temperature 30° C. with an initial measurement strain 0.01% to measure storage modulus G′, loss modulus G″, and tan δ at intervals of 1° C. during heating. During temperature rising, the strain is controlled up to the maximum strain of about 20% so that the detected torque is about 10 gcm. The measurement is stopped when the detected torque is below the lower limit of measurement guaranteed value.

The toner used in this exemplary embodiment and satisfying the above-described characteristics is described in further detail below.

In the exemplary embodiment, the toner contains a binder resin and, if required, a release agent, a coloring agent, and various additives. The toner may contain external additives.

### <Binder Resin>

In the exemplary embodiment, a polyester resin is used as the binder resin of the toner, and, if required, another binder resin (e.g., a styrene acrylic resin) other than the polyester resin may be used in combination with the polyester resin. However, when another binder resin is used in combination with the polyester resin, the ratio of the polyester resin in the whole binder resin is preferably about 50% or more and more preferably about 70% or more.

As the polyester resin, any one of a crystalline polyester resin and a noncrystalline polyester resin may be selected and used, or both resins may be combined. When a low-temperature fixing property is imparted to the toner, a crystalline polyester resin is used.

From the viewpoint of balance between various characteristics such as the low-temperature fixing property, toner strength, and the like, a combination of a crystalline polyester resin having a sharp melting property and a noncrystalline resin is used as the binder resin.

In this case, the melting point and glass transition temperature of the binder resins are in the range of about 45° C. to 110° C. and more preferably in the range of about 60° C. to 90° C.

The mixing ratio between two types of binder resins is selected in consideration of a relation between the melting point of a crystalline polyester resin and the glass transition temperature of a noncrystalline resin. Since the thermal melting properties of a component at a higher content generally become a dominant factor, it is desirable to select a resin component that does not inhibit the low-temperature fixing property.

The melting point is determined as a melting peak temperature in input compensation differential scanning calorimetry on the basis of JIS K 7121. Although a crystalline resin may show plural melting peaks, in this case, the maximum peak is considered as the melting point.

### [Crystalline Polyester Resin]

A polyester resin is synthesized from a polyvalent carboxylic acid component an a polyhydric alcohol component. In this exemplary embodiment, a commercial polyester resin may be used or an appropriate synthetic polyester resin may be used. The polyvalent carboxylic acid component and the polyhydric alcohol component desirable for synthesizing the crystalline polyester resin are described below.

Examples of the polyvalent carboxylic acid component include, but are not limited to, aliphatic dicarboxylic acids such as oxalic acid, succinic acid, glutaric acid, adipic acid, speric acid, azelaic acid, sebacic acid, 1,9-nonanedicarboxylic acid, 1,10-decanedicarboxylic acid, 1,12-dodecanedicarboxylic acid, 1,14-tetradecanedicarboxylic acid, 1,18-octadecanedicarboxylic acid, and the like; aromatic dicarboxylic acids as dibasic acids such as phthalic acid, isophthalic acid, terephthalic acid, naphthalene-2,6-dicarboxylic acid, malonic acid, mesaconic acid, and the like; and anhydrides and lower alkyl esters thereof.

Examples of a trivalent or higher carboxylic acid include 1,2,4-benzenetricarboxylic acid, 1,2,5-benzenetricarboxylic acid, 1,2,4-naphthalenetricarboxylic acid, and the like; and anhydrides and lower alkyl esters thereof. These may be used alone or in combination of two or more.

Besides the aliphatic dicarboxylic acid and aromatic dicarboxylic acid, a dicarboxylic acid component having a sulfonic acid group is preferably used as the polyvalent carboxylic acid component. The dicarboxylic acid component having a sulfonic acid group is effective in respect of improvement in dispersion of a coloring agent such as a pigment. When resin particles are formed by emulsifying or suspending the whole resin in water, emulsification or suspension may be performed without using a surfactant in the presence of a sulfonic acid group as described below.

Examples of the dicarboxylic acid component having a sulfonic acid group include, but are not limited to, sodium 2-sulfoterephthalate, sodium 5-sulfoisophthalate, sodium sulfosuccinate, and the like; and lower alkyl esters and anhydrides thereof. The content of the divalent or higher carboxylic acid component having a sulfonic acid group is preferably in the range of about 1 to 15 mol % and more preferably in the range of about 2 to 10 mol % based on all carboxylic acid components constituting the polyester.

When the content is about 1 mol % or more, the temporal stability of resin particles is desirably improved. While when the content is about 15 mol % or less, the crystallinity of the crystalline polyester resin is desirably improved. In use as the binder resin, it is desirably easy to control the toner particle diameter in a fusion step after aggregation.

Besides the aliphatic dicarboxylic acid and aromatic dicarboxylic acid, a dicarboxylic acid component having a double bond is more preferably used. The dicarboxylic acid having a double bond is used for preventing hot offset during fixing in respect of formation of a radical crosslinking bond through a double bond. Examples of the dicarboxylic acid having a double bond include, but are not limited to, maleic acid, fumaric acid, 3-hexenedioic acid, 3-octenedioic acid, and the like; and lower esters and acid anhydrides thereof. Among these, fumaric acid or maleic acid is used from the viewpoint of cost.

As the polyhydric alcohol component, an aliphatic diol is preferred, and a straight-chain aliphatic diol having about 7 to 20 carbon atoms in a main chain is more preferred. When the aliphatic diol has a straight chain, the polyester resin desirably has good crystallinity and a high melting point, thereby exhibiting excellent anti-toner blocking property, image storage property, and low-temperature fixing property.

When the carbon number is about 7 or more, even in polycondensation with an aromatic carboxylic acid, a low melting point and excellent low-temperature fixing property are desirably exhibited. While when the carbon number is about 20 or less, materials are desirably easy available. The carbon number is more preferably about 14 or less.

Specific examples of the aliphatic diol desirably used for synthesizing the crystalline polyester include, but are not limited to, ethylene glycol, 1,3-propanediol, 1,4-butanediol, 1,5-pentanediol, 1,6-hexanediol, 1,7-heptanediol 1,8-octanediol, 1,9-nonanediol, 1,10-decanediol, 1,11-undecanediol, 1,12-dodecanediol, 1,13-tridecanediol, 1,14-tetradecanediol, 1,18-octadecanediol, 1,14-eicosanedecanediol, and the like. Among these, 1,8-octanediol, 1,9-nonanediol, and 1,10-decanediol are preferred in view of easy availability.

Examples of trihydric or higher alcohols include glycerin, trimethylolethane, trimethylolpropane, pentaerythritol, and the like. These may be used alone or in combination of two or more

The content of an aliphatic diol component in the polyhydric alcohol component is preferably about 80 mol % or more and more preferably about 90 mol % or more. When the content of the aliphatic diol component is about 80 mol % or more, the polyester resin desirably exhibits good crystallinity and no decrease in the melting point, thereby causing excellent anti-toner blocking properties, image storage properties, and low-temperature fixing properties.

If required, a monovalent acid such as acetic acid, benzoic acid, or the like, and a monohydric alcohol such as cyclohexanol, benzyl alcohol, or the like are used for controlling an acid value, hydroxyl group value, and the like.

The term “crystalline” of the crystalline polyester resin represents that differential scanning calorimetry shows a clear endothermic peak, not stepwise endothermic changes. Specifically, the term represents that in measurement at a heating rate of about 10° C./min, the half-peak width of an endothermic peak is about 6° C. or less. On the other hand, a resin showing a half-peak width of over about 6° C. and a resin showing no clear endothermic peak are indicated as noncrystalline resins. However, in the exemplary embodiment, a resin showing no clear endothermic peak is preferably used as the noncrystalline resin.

The “crystalline polyester resin” represents a polymer having 100% of a constituent component having a polyester structure and a polymer (copolymer) produced by polymerizing a constituent component of polyester and another component. However, in the latter case, the content of the other constituent component other than the polyester component in the polymer (copolymer) is about 50% by weight or less.

The acid value (number of mg of KOH required for neutralizing 1 g of resin) of the polyester resin is preferably about 1 to 30 mgKOH/g because a desired molecular weight distribution is easily obtained, granulation of toner particles is easily secured by the emulsion-dispersion method, and good environmental stability (stability of charging properties when temperature and humidity change) of the resultant toner is easily maintained. The acid value of the polyester resin is adjusted by controlling the terminal carboxyl groups of polyester on the basis of the fixing ratio and reaction rate between the polyvalent carboxylic acid and polyhydric alcohol used as raw materials. A polyester having a carboxyl group in a main chain thereof may be prepared by using trimellitic anhydride as a polyvalent carboxylic acid component.

### [Noncrystalline Resin]

In the exemplary embodiment, for example, a generally known thermoplastic binder resin is used as the noncrystalline resin in the toner. Specific examples of such a resin include homopolymers or copolymers (styrene resins) of styrenes such as styrene, parachlorostyrene, α-methylstyrene, and the like; homopolymers or copolymers (vinyl resins) of vinyl-containing esters such as methyl acrylate, ethyl acrylate, n-propyl acrylate, n-butyl acrylate, lauryl acrylate, 2-ethylhexyl acrylate, methyl methacrylate, ethyl methacrylate, n-propyl methacrylate, lauryl methacrylate, 2-ethylhexyl methacrylate, and the like; homopolymers or copolymers (vinyl resins) of vinylnitriles such as acrylonitrile, methacrylonitrile, and the like; homopolymers or copolymers (vinyl resins) of vinyl ethers such as vinyl methyl ether, vinyl isobutyl ether, and the like; homopolymers or copolymers (vinyl resins) of vinyl ketones such as vinyl methyl ketone, vinyl ethyl ketone, vinyl isopropenyl ketone, and the like; homopolymers or copolymers (olefin resins) of olefins such as ethylene, propylene, butadiene, isoprene, and the like; non-vinyl condensed resins such as epoxy resins, polyester resins, polyurethane resins, polyamide resins, cellulose resins, polyether resins, and the like; and graft copolymers of these non-vinyl condensed resins with vinyl monomers.

These resins may be used alone or in combination of two or more. Among these resins, the vinyl resins and the polyester resins are particularly preferred.

In the exemplary embodiment, it is effective to use a polyester resin as a noncrystalline component in the toner binder resins because a resin particle dispersion is easily prepared by controlling the acid value of the resin and emulsifying and dispersing the resin using an ionic surfactant or the like. The noncrystalline polyester resin used in emulsion-dispersion is synthesized by dehydration condensation of a polyvalent carboxylic acid and a polyhydric alcohol.

Examples of the polyvalent carboxylic acid include aromatic carboxylic acids such as terephthalic acid, isophthalic acid, phthalic anhydride, trimellitic anhydride, pyromellitic acid, naphthalenedicarboxylic acid, and the like; aliphatic carboxylic acids such as maleic anhydride, fumaric acid, succinic acid, alkenyl succinic anhydride, adipic acid, and the like; alicyclic carboxylic acids such as cyclohexanedicarboxylic acid and the like. These polyvalent carboxylic acids are used alone or in combination of two or more. Among these polyvalent carboxylic acids, the aromatic carboxylic acids are preferred. In order to form a crosslinked or branched structure for securing good fixing properties or to control the molecular weight, it is also preferred to use a trivalent or higher carboxylic acid (trimellitic acid or anhydride thereof) together with the dicarboxylic acid.

Examples of the polyhydric alcohol include aliphatic diols such as ethylene glycol, diethylene glycol, triethylene glycol, propylene glycol, butanediol, hexanediol, neopentyl glycol, glycerin, and the like; alicyclic diols such as cyclohexanediol, cyclohexanedimethanol, hydrogenated bisphenol A, and the like; and aromatic diols such as bisphenol A ethylene oxide adduct, bisphenol A propylene oxide adduct, and the like. At least one of these polyhydric alcohols is used. Among these polyhydric alcohols, the aromatic diols and the alicyclic dials are preferred, and the aromatic diols are more preferred. In order to form a crosslinked or branched structure for securing good fixing properties, a trihydric or higher alcohol (glycerin, trimethylolpropane, or pentaerythritol) may be used together with the dial.

In order to control the acid value of the polyester resin produced by polycondensation of the polyvalent carboxylic acid and the polyhydric alcohol, a hydroxyl group and/or a carboxyl group at a polymer end may be esterified by adding a monocarboxylic acid and/or a monoalcohol to the polyester resin. Examples of the monocarboxylic acid include acetic acid, acetic anhydride, benzoic acid, trichloroacetic acid, trifluoroacetic acid, propionic anhydride, and the like. Examples of the monoalcohol include methanol, ethanol, propanol, octanol, 2-ethylhexanol, trifluoroethanol, trichloroethanol, hexafluoroisopropanol, phenol, and the like.

The polyester resin used in the exemplary embodiment is produced by condensation reaction of the polyhydric alcohol and the polyvalent carboxylic acid according to a usual method. For example, the polyhydric alcohol and the polyvalent carboxylic acid, and, if required, a catalyst are mixed in a reactor provided with a thermometer, a stirrer, and a falling-type condenser and heated to about 150° C. to 250° C. in the presence of inert gas (nitrogen gas or the like) to continuously remove low-molecular compounds as by-products to the outside of the reaction system. When a predetermined acid value is attained, the reaction is terminated, and the system is cooled to obtain a target product.

### <Method for Producing Toner>

In the exemplary embodiment, a toner is produced by an emulsion-aggregation method. In producing the toner by the emulsion-aggregation method, each of the materials constituting the toner is dispersed in an aqueous dispersion liquid to prepare a dispersion solution (a resin particle dispersion solution or the like) (emulsification step). Then, the resin particle dispersion solution and various dispersion solutions (a coloring agent dispersion solution, a release agent dispersion solution, and the like) used according to demand are mixed to prepare a raw material dispersion solution.

Next, in the raw material dispersion solution, toner mother particles are produced through an aggregated particle forming step of forming aggregated particles and a fusion step of fusing the aggregated particles. When a toner having a so-called core-shell structure including a core layer and a shell layer that coats the core layer is formed, after the aggregated particle forming step, a coating layer forming step is performed to form coating layers (shell layer in the toner) by adding a resin particle dispersion to the raw material dispersion solution to adhere resin particles to the surfaces of aggregated particles (the core layers of the toner). Thereafter, the fusion step is performed. The resin component used in the coating layer forming step may be the same as or different from that constituting the core layer. However, a noncrystalline resin is generally used.

Each of the steps is described in detail below.

### [Emulsification Step]

In order to prepare the raw material dispersion solution used in the aggregated particle forming step, in the emulsification step, each of the major materials constituting the toner is dispersed in an aqueous medium to prepare an emulsion dispersion solution. Hereinafter, the resin particle dispersion solution and the coloring agent dispersion solution, the release agent dispersion solution, and the like used according to demand are described.

### —Resin Particle Dispersion Solution—

The volume average particle diameter of the resin particles dispersed in the resin particle dispersion solution is preferably about 0.01 to 1 μm, more preferably about 0.03 to 0.8 μm, and most preferably about 0.03 to 0.6 μm.

When the volume-average particle diameter of the resin particles is about 1 μm or less, the finally produced toner desirably has a narrow particle size distribution, and the occurrence of free particles is suppressed, thereby improving performance and reliability.

The volume average particle diameter within this range is effective in that the above-described defects are removed, uneven distribution of compositions between toners is decreased, and the dispersion in the toner is improved, thereby decreasing variation in performance and reliability.

The volume average particle diameter of the particles contained in the raw material dispersion, such as the resin particles, is measured using a laser diffraction particle size analyzer (manufactured by Horiba, Ltd., LA-700).

As the dispersion medium used for the resin particle dispersion and other dispersions, an aqueous medium is preferred.

Examples of the aqueous medium include water such as distilled water, ion-exchanged water, and the like; and alcohols. These may be used alone or in combination of two or more. In the exemplary embodiment, a surfactant is previously added and mixed with the aqueous medium.

Examples of the surfactant include, but are not limited to, anionic surfactants such as sulfuric acid ester salts, sulfonic acid salts, phosphoric acid esters, soaps, and the like; cationic surfactants such as amine salts, quaternary ammonium salts, and the like; and nonionic surfactants such as polyethylene glycol, alkylphenol ethylene oxide adducts, polyhydric alcohols, and the like. Among these surfactants, the anionic surfactants and the cationic surfactants are preferred. The nonionic surfactant is preferably used in combination with the anionic surfactant or the cationic surfactant. These surfactants may be used alone or in combination of two or more.

Specific examples of the anionic surfactants include sodium dodecylbenzenesulfonate, sodium dodecyl sulfate, sodium alkylnaphthalenesulfonate, sodium dialkylsulfosuccinate, and the like. Specific examples of the cationic surfactants include alkylbenzene dimethylammonium chloride, alkyltrimethylammonium chloride, distearylammonium chloride, and the like. Among these, ionic surfactants such as the anionic surfactants and the cationic surfactants are preferred.

When the resin particles are made of a polyester resin, the particles have self-water dispersibility due to functional groups capable of becoming an anionic form through neutralization and thus form a stable aqueous dispersion under the action of an aqueous medium through neutralization of the entire or a part of the functional groups capable of becoming hydrophilic groups with a base.

The functional groups capable of becoming hydrophilic groups in the polyester resin through neutralization are acidic groups such as carboxyl groups, sulfonic groups, or the like so that examples of a neutralizer include inorganic bases such as sodium hydroxide, potassium hydroxide, lithium hydroxide, calcium hydroxide, sodium carbonate, ammonia, and the like, and organic bases such as diethylamine, triethylamine, isopropylamine, and the like.

When a binder resin other than the polyester resin is used in combination with the polyester resin, like in the case of a release agent dispersion solution described below, a resin particle dispersion solution of the binder resin is prepared by dispersing an ionic surfactant, a high-molecular electrolyte such as a high-molecular acid, a high-molecular base, or the like in a resin solution and/or an aqueous medium mixed with the resin solution, heating the resultant dispersion solution to the melting point of the binder resin or higher, and then applying strong shearing force using a homogenizer or a pressure discharge disperser.

In this case, the rein particles having a volume-average particle diameter of about 0.5 μm or less are easily formed. When the ionic surfactant and the high-molecular electrolyte are used, the concentration in the aqueous medium is adjusted to about 0.5 to 5% by weight.

On the other hand, when the resin particle dispersion solution is prepared using the polyester resin, a phase inversion emulsification method is used. Also, when the resin particle dispersion solution is prepared using the binder resin other than the polyester resin, the phase inversion emulsification method may be used.

The phase inversion emulsification method includes dissolving a resin to be dispersed in a hydrophobic organic solvent capable of dissolving the resin, neutralizing an organic continuous phase (O phase) by adding a base, and converting a resin emulsion (so-called phase inversion) from W/O to O/W by adding an aqueous medium (W phase) to form a discontinuous phase, thereby stably dispersing the resin as particles in the aqueous medium.

Examples of the organic solvent used in the phase inversion emulsification include alcohols such as ethanol, n-propanol, isopropanol, n-butanol, isobutanol, sec-butanol, tert-butanol, n-amyl alcohol, isoamyl alcohol, sec-amyl alcohol, tert-amyl alcohol, 1-ethyl-1-propanol, 2-methyl-1-butanol, n-hexanol, cyclohexanol, and the like; ketones such as methyl ethyl ketone, methyl isobutyl ketone, ethyl butyl ketone, cyclohexanone, isophorone, and the like; ethers such as tetrahydrofuran, dimethyl ether, diethyl ether, dioxane, and the like; esters such as methyl acetate, ethyl acetate, n-propyl acetate, isopropyl acetate, n-butyl acetate, isobutyl acetate, sec-butyl acetate, 3-methoxybutyl acetate, methyl propionate, ethyl propionate, butyl propionate, dimethyl oxalate, diethyl oxalate, dimethyl succinate, diethyl succinate, diethyl carbonate, dimethyl carbonate, and the like; glycol derivatives such as ethylene glycol, ethylene glycol monomethyl ether, ethylene glycol monoethyl ether, ethylene glycol monopropyl ether, ethylene glycol monobutyl ether, ethylene glycol ethyl ether acetate, diethylene glycol, diethylene glycol monomethyl ether, diethylene glycol monoethyl ether, diethylene glycol monopropyl ether, diethylene glycol monobutyl ether, diethylene glycol ethyl ether acetate, propylene glycol, propylene glycol monomethyl ether, propylene glycol monopropyl ether, propylene glycol monobutyl ether, propylene glycol methyl ether acetate, dipropylene glycol monobutyl ether, and the like; 3-methoxy-3-methylbutanol; 3-methoxybutanol; acetonitrile; dimethylformamide; dimethylacetamide; diacetone alcohol; ethyl acetoacetate; and the like. These solvents may be used alone or in combination of two or more.

With respect to the amount of the organic solvent used for phase inversion emulsification, since the solvent amount for obtaining a desired dispersed particle diameter varies with the physical properties of the resin, it is difficult to determine the solvent amount unconditionally. However, in the exemplary embodiment, the content of a tin compound catalyst in the resin is larger than that in a general polyester resin, and thus the solvent amount is relatively large based on the weight of the resin. When the solvent amount is small, emulsification properties may become unsatisfactory, thereby increasing the particle diameter or broadening the particle size distribution of the resin particles.

When the binder resin is dispersed in water, if required, part or all of the carboxyl groups in the resin are neutralized with a neutralizer. Examples of the neutralizer include inorganic alkalis such as potassium hydroxide, sodium hydroxide, and the like; amines such as ammonia, monomethylamine, dimethylamine, triethylamine, monoethylamine, diethylamine, triethylamine, mono-n-propylamine, dimethyl-n-propylamine, monoethanolamine, diethanolamine, triethanolamine, N-methylethanolamine, N-aminoethylethanolamine, N-methyldiethanolamine, monoisopropanolamine, diisopropanolamine, triisopropanolamine, N,N-dimethylpropanolamine, and the like. At least one neutralizer is selected from these neutralizers. The pH in emulsification is controlled to be near neutral by adding such a neutralizer, thereby preventing hydrolysis of the resultant polyester resin dispersion solution.

In addition, a dispersant may be added for the purpose of stabilizing dispersed particles and preventing thickening of the aqueous medium during phase inversion emulsification. Examples of the dispersant include water-soluble polymers such as polyvinyl alcohol, methyl cellulose, ethyl cellulose, hydroxyethyl cellulose, carboxymethyl cellulose, sodium polyacrylate, sodium polymethacrylate, and the like; anionic surfactants such as sodium dodecylbenzenesolfonate, sodium octadecylsulfate, sodium oleate, sodium laurate, potassium stearate, and the like; cationic surfactants such as laurylamine acetate, stearylamine acetate, lauryltrimethylammonium chloride, and the like; amphionic surfactants such as lauryldimethylamine oxide and the like; nonionic surfactants such as polyoxyethylene alkyl ethers, polyoxyethylene alkyl phenyl ethers, polyoxyethylene alkyl amines, and the like; and inorganic compounds such as tricalcium phosphate, aluminum hydroxide, calcium sulfate, calcium carbonate, barium carbonate; and the like. These dispersants may be used alone or in combination of two or more. The dispersant is added in an amount of about 0.01 to 20 parts by weight based on 100 parts by weight of the binder resin.

In the phase inversion emulsification, the emulsification temperature is the boiling temperature of the organic solvent or lower and is the melting point or glass transition point of the binder resin or higher. When the emulsification temperature is higher than the melting point or glass transition point of the binder resin, the resin particle dispersion solution is desirably easily prepared. When the emulsification is performed at the boiling point of the organic solvent or higher, the emulsification may be performed in a pressure-closed apparatus.

The content of the resin particles in the resin particle dispersion solution is preferably about 5 to 50% by weight and more preferably about 10 to 40% by weight. With the resin particles at a content within this range, the resin particles desirably have a narrow particle size distribution, thereby exhibiting good characteristics.

### —Coloring Agent Dispersion Solution—

As a method for dispersing the coloring agent for preparing the coloring agent dispersion solution, any desired dispersion method, such as a rotary shearing homogenizer, a ball mill including a medium, a sand mill, or a dyno-mill, may be used without any limitation. If required, an aqueous dispersion solution of the coloring agent may be prepared using a surfactant, or an organic solvent dispersion solution of the coloring agent may be prepared using a dispersant.

As the surfactant or the dispersant used for dispersion, the same dispersant as for dispersing the binder resin may be used.

In preparing the raw material dispersion solution, the coloring agent dispersion solution may be mixed at a time or may be divided and mixed in plural stages together with other dispersion solutions containing particles dispersed therein.

The content of the coloring agent particles in the coloring agent dispersion solution is preferably about 5 to 50% by weight and more preferably about 10 to 40% by weight. With the coloring agent particles at a content within this range, the coloring agent particles desirably have a narrow particle size distribution, thereby exhibiting good characteristics.

### —Release Agent Dispersion Solution—

Like in emulsion-dispersion of the binder resin other than the polyester resin, the release agent dispersion solution is prepared by dispersing the release agent in water together with the ionic surfactant or the like, heating the dispersion to the melting point of the release agent or higher, and applying strong shearing force using a homogenizer or a pressure-discharge disperser. As a result, release agent particles having a volume average particle diameter of about 1 μm or less are dispersed. As a dispersion medium in the release agent dispersion solution, the same dispersion medium as used for the binder resin may be used.

As an emulsion-dispersing apparatus for mixing the binder resin, the coloring agent, etc. with the dispersion medium, a known continuous emulsion disperser, for example, Homomixer (Tokushu Kika Kogyo Co., Ltd.), Slusher (Mitsui Mining Co., Ltd.), Cavitron (Eurotec Co., Ltd.), Microfluidizer (Mizuho Industrial Co., Ltd.), Manton Gaulin Homogenizer (Gaulin Co., Ltd.), Nanomizer (Nanomizer Co., Ltd.), Static Mixer (Noritake Co., Ltd.), or the like may be used.

According to the purpose, other components such as a release agent, an internal additive, a charge control agent, an inorganic powder, and the like as described above may be dispersed in the binder resin dispersion solution.

In preparing another dispersion solution containing another component other than the binder resin, the coloring agent, and the release agent, the volume average particle diameter of particles dispersed in the dispersion solution is preferably about 1 μm or less and more preferably about 0.01 to 0.5 μm. When the volume-average particle diameter is about 1 μm or less, the resultant particles desirably have a narrow particle size distribution and the occurrence of free particles is suppressed, thereby improving performance and reliability. Further, the volume-average particle diameter within the above range is effective in that the above-described defects are eliminated, uneven distribution between toners is decreased, and dispersion in the toner particles is improved, thereby decreasing variation in performance and reliability.

### [Aggregated Particle Forming Step]

In the aggregated particle forming step, an aggregating agent is further added to the raw material dispersion solution. The raw material dispersion solution is prepared by generally adding, besides the resin particle dispersion solution, the coloring agent dispersion solution, and another dispersion solution (e.g., the release agent dispersion solution containing the release agent dispersed therein or the like) to be added according to demand. The resultant mixture is heated to aggregate the particles, forming aggregated particles. When the resin particles are particles of a crystalline resin such as crystalline polyester or the like, the mixture is heated at a temperature close to the melting point of the crystalline resin and lower than the melting point to aggregate the particles, thereby forming aggregated particles.

The aggregated particles are formed by adding the aggregating agent at room temperature under stirring with a rotary shearing homogenizer and adjusting the raw material dispersion solution to acidic pH. In order to suppress rapid aggregation by heating, the pH is adjusted in the step of stirring and mixing at room temperature and a dispersion stabilizer is added according to demand.

As the aggregating agent used in the aggregated particle forming step, a surfactant of polarity reverse to the surfactant used as the dispersant added to the raw material dispersion solution, i.e., an inorganic metal salt, or a divalent or higher metal complex is preferably used. In particular, a metal complex is preferred because the amount of the surfactant used is decreased, and the charging properties are improved.

Further, an additive that forms a complex or a complex-like bond to a metal ion of the aggregating agent used is added according to demand. As the additive, a chelating agent is preferably used.

Examples of the inorganic metal salt include metal salts such as calcium chloride, calcium nitrate, barium chloride, magnesium chloride, zinc chloride, aluminum chloride, aluminum sulfate, and the like; and inorganic metal salt polymers such as polyaluminum chloride, polyaluminum hydroxide, calcium polysulfide, and the like. In particular, aluminum salts and polymers thereof are preferred. In order to obtain a sharper particle size distribution, the valence of the inorganic metal salt is suitably divalent rather than monovalent, trivalent rather than divalent, and tetravalent rather than trivalent. Even with the same valence, a polymerization-type inorganic metal salt polymer is more preferred.

As the chelating agent, a water-soluble chelating agent is preferably used. A water-insoluble chelating agent has low dispersibility in the raw material dispersion solution, and thus metal ions due to the aggregating agent may not be sufficiently trapped in the toner.

The chelating agent is not particularly limited as long as it is a known water-soluble chelating agent. Examples of the chelating agent include oxycarboxylic acids such as tartaric acid, citric acid, gluconic acid, and the like; iminodiacetic acid (IDA), nitrilotriacetic acid (NTA), ethylenediaminetetraacetic acid (EDTA), and the like.

The amount of the chelating agent added is preferably about 0.01 to 5.0 parts by weight and more preferably about 0.1 to 3.0 parts by weight based on 100 parts by weight of the binder resin. When the amount of the chelating agent added is about 0.01 parts by weight or more, the effect of addition of the chelating agent is achieved. When the amount is about 5.0 parts by weight or less, desirably, good charging properties and toner viscoelasticity are achieved, and good low-temperature fixing properties and image gloss are achieved.

The chelating agent is added during or before or after the aggregated particle forming step and the coating layer forming step. When the chelating agent is added, the temperature of the raw material dispersion solution may not be controlled. The chelating agent may be added at room temperature or added after the temperature is controlled to a bath temperature in the aggregated particle forming step and the coating layer forming step without any limitation.

### [Coating Layer Forming Step]

After the aggregated particle forming step, if required, the coating layer forming step may be performed. In the coating layer forming step, coating layers are formed by allowing resin particles for forming coating layers to adhere to the surfaces of the aggregated particles formed in the aggregated particle forming step. As a result, a toner having a so-called core-shell structure is produced.

The coating layers are generally formed by adding a resin particle dispersion solution containing noncrystalline resin particles to the raw material dispersion solution containing the aggregated particles (core particles) formed in the aggregated particle forming step.

After the coating layer forming step is completed, the fusion step is performed. However, coating layers may be formed in multiple stages by alternately repeating the coating layer forming step and the fusion step.

### [Fusion Step]

In the fusion step performed after the aggregated particle forming step or after the aggregated particle forming step and the coating layer forming step, the pH of a suspension containing the aggregated particles formed through these steps is adjusted within a range of about 6.5 to 8.5 to stop the progress of aggregation.

After the progress of aggregation is stopped, the aggregated particles are fused by heating. When a crystalline resin is used as the binder resin, the aggregated particles are fused by heating at a temperature higher than the melting point of the binder resin.

### [Washing and Drying Step]

After completion of the fusion step for the aggregated particles, desired toner particles are produced through a desired washing step, solid-liquid separation step, and drying step. In the washing step, the dispersant adhering to the toner mother particles is removed with an aqueous solution of a strong acid such as hydrochloric acid, sulfuric acid, nitric acid, or the like, and then the particles are sufficiently washed with ion-exchanged water until a filtrate becomes neutral. The solid-liquid separation step is not particularly limited, but suction filtration, pressure filtrate, and the like are preferred from the viewpoint of productivity. The drying step is also particularly limited, but freeze drying, flash jet drying, fluidized drying, vibration-type fluidized drying, and the like are preferred from the viewpoint of productivity.

The drying step is performed by any desired method such as usual vibration-type fluidized drying, spray drying, freeze drying, flash jet drying, or the like. In this step, the water content in the toner mother particles after drying is preferably controlled to about 1.0% by weight or less and more preferably about 0.5% by weight or less.

In addition, the various external additives described above may be added to the toner mother particles after drying.

With respect to the volume-average particle diameter of the toner, the volume-average particle diameter D₅₀ measured with a coulter counter is preferably about 4.0 to 10.0 μm, more preferably about 5.0 to 8.0 μm, and most preferably about 5.0 to 7.0 μm. When the volume-average particle diameter D₅₀ is about 4.0 μm or more, the occurrence of cloud due to flying of the toner is prevented. While when the volume-average particle diameter D₅₀ is about 10.0 μm or less, a good image is obtained.

The particle diameter is measured by using coulter counter TA-II model (manufactured by Beckmann-Coulter Inc.) and adding about 0.5 to 50 mg of a measurement sample (toner) to about 2 ml of a 5% aqueous solution of a surfactant serving as a dispersant, preferably sodium alkylbenzenesulfonate. Further, the dispersion is added to about 100 to 150 ml of an electrolytic solution.

The electrolytic solution containing the measurement sample suspended therein is subjected to dispersion treatment for about 1 minute using an ultrasonic disperser. Then, a particle size distribution of particles of about 2.0 to 60 μm is measured with the coulter counter TA-II model using a 100 μm aperture as an aperture diameter to determine a volume-average distribution and a number-average distribution. The number of the particles measured is about 50,000. A volume-average particle diameter is determined from the volume-average distribution and the number-average distribution. A particle size distribution is determined by drawing a cumulative distribution of each of volume and number starting from the smaller-particle-diameter side with respect to divided particle size ranges (channels). A particle size at an accumulation of 50% is defined as the volume-average particle diameter D₅₀.

In the particle size distribution of the toner, the ratio (D84v/D16v)^{1/2} (GSDv: volume-average particle size distribution index) of a diameter (D84v) at an accumulation of 84% to a diameter (D16v) at an accumulation of 16% for the volume-average particle diameter measured by the coulter counter is preferably about 1.30 or less, and the ratio (D84p/D16p)^{1/2} (GSDp: number-average particle size distribution index) for the number-average particle diameter is preferably about 1.40 or less. When GSDv is about 1.30 or less and GSDp is about 1.40 or less, a high-quality image is desirably obtained.

### EXAMPLES

The present invention is described in further detail below with reference to examples. However, the present invention is not limited to these examples. Hereinafter, “parts” and “%” represent “parts by weight” and “% by weight”, respectively.

### (Preparation of Toner)

### <Preparation of Crystalline Resin Particle Dispersion 1>

In a three-necked flask dried by heating, 225 parts by weight of 1,10-dodecanedioic acid, 160 parts by weight of 1,9-nonanediol, and 0.8 parts by weight of dibutyltin oxide as a catalyst were placed. Then, air in the three-necked flask was replaced with nitrogen by a vacuum operation to create an inert atmosphere, and reaction is proceeded by mechanical stirring at 180° C. for 5 hours under reflux. During the reaction, water produced in the reaction system was distilled off. Then, the temperature was gradually increased to about 230° C. under reduced pressure. When a viscous state was observed after stirring four 2 hours, a molecular weight was determined by GPC. When the weight-average molecular weight was about 29,000, reduced-pressure distillation was stopped to obtain a crystalline polyester resin.

Next, 100 parts by weight of the resultant crystalline polyester resin, 40 parts by weight of methyl ethyl ketone, and 30 parts by weight of isopropyl alcohol were placed in a separable flask, followed by sufficient mixing and dissolution at 75° C. Then, 6.0 parts by weight of a 10 wt % aqueous ammonia solution was added dropwise.

The heating temperature was decreased to about 60° C., and ion-exchanged water was added dropwise at a feed rate of about 6 g/min under stirring using a feed pump. After the solution became uniformly cloudy, the feed rate was increased to about 25 g/min. When the total liquid amount was about 400 parts by weight, dropping of ion-exchanged water was stopped. Then, the solvent was removed under reduced pressure to produce a crystalline resin particle dispersion 1. The volume-average particle diameter of the resultant crystalline resin particles was about 168 nm, and the solid content thereof was about 11.5% by weight.

### <Preparation of Noncrystalline Resin Particle Dispersion 1>

In a three-necked flask dried by heating, 265 parts by weight of bisphenol A propylene oxide 2-mole adduct, 260 parts by weight of terephthalic acid, 40 parts by weight of fumaric acid, 50 parts by weight of dodecenylsuccinic acid, 18 parts by weight of trimellitic anhydride, 0.8 part by weight of dibutyltin oxide were placed. Then, air in the three-necked flask was evacuated by a vacuum operation and replaced with nitrogen gas to create an inert atmosphere, and reflux was performed under mechanical stirring at 180° C. for 5 hours.

Then, the temperature was gradually increased to about 240° C. while water produced in the flask was removed by reduced-pressure distillation. Further, dehydration condensation reaction was continued for about 4 hours at about 240° C. When a viscous state was observed, a molecular weight was determined by GPC. When the weight-average molecular weight was about 65,700, reduced-pressure distillation was stopped to obtain a noncrystalline polyester resin (1).

Next, 100 parts by weight of the resultant noncrystalline polyester resin (1), 50 parts by weight of methyl ethyl ketone, 30 parts by weight of isopropyl alcohol, and 5 parts by weight of a 10 wt % aqueous ammonia solution were placed in a separable flask, followed by sufficient mixing and dissolution. Then, ion-exchanged water was added dropwise at a feed rate of about 8 g/min using a feed pump under heat-stirring at about 40° C.

After the solution in the flask became uniformly cloudy, the feed rate was increased to about 25 g/min to produce phase inversion. When the total liquid amount was about 135 parts by weight, dropping of ion-exchanged water was stopped. Then, the solvent was removed under reduced pressure to produce a noncrystalline resin particle dispersion 1. The volume-average particle diameter of the resultant polyester resin particles was about 156 nm, and the solid content thereof was about 38% by weight.

### <Preparation of Noncrystalline Resin Particle Dispersion 2>

A noncrystalline polyester resin (2) having a weight-average molecular weight of about 48,300 was prepared by the same method as for the noncrystalline polyester resin (1) except that 16 parts by weight of trimellitic anhydride was used, and the dehydration polycondensation reaction time was about 2.5 hours.

Next, a noncrystalline resin particle dispersion 2 was prepared by the same method as for the noncrystalline resin particle dispersion 1 except that the noncrystalline polyester resin (2) was used in place of the noncrystalline polyester resin (1). The volume-average particle diameter of the resultant polyester resin particles was about 162 nm, and the solid content thereof was about 37% by weight.

### <Preparation of Coloring Agent Particle Dispersion 1>

The components below were mixed and dissolved and dispersed for 10 minutes using a homogenizer (IKA Ultra-Turrax) to prepare a coloring agent particle dispersion 1 having a volume-average particle diameter of about 168 nm and a solid content of about 22.0% by weight.

| | |
|---|---|
| Cyan pigment (copper phthalocyanine B15:3, | 45 parts by weight |
| manufactured by Dainichi Seika, Ltd.) | |
| Nonionic surfactant (Nonipole 400, manufactured by | 5 parts by weight |
| Sanyo Chemical Industries, Ltd.) | |
| Ion-exchanged water | 200 parts by weight |

### <Preparation of Release Agent Particle Dispersion 1>

The components below were heated to about 95° C. and sufficiently dispersed using IKA Ultra-Turrax T50 and then dispersed using pressure-discharge Gaulin homogenizer to prepare a release agent particle dispersion 1 having a volume-average particle diameter of about 205 nm and a solid content of about 20% by weight.

| | |
|---|---|
| Paraffin wax HNP9 | 45 parts by weight |
| (release agent with melting temperature 72° C. | |
| and acid value 0 mgKOH/g, manufactured by | |
| Nippon Seiro Co., Ltd.) | |
| Anionic surfactant Neogen RK (manufactured by | 5 parts by weight |
| Daiichi Kogyo Seiyaku Co., Ltd.) | |
| Ion-exchanged water | 200 parts by weight |

### <Preparation of Toner (Preparation of Toner 1)>

The components below were sufficiently mixed and dispersed in a round-bottomed flask using a homogenizer (IKA Ultra-Turrax T50). Then, 1.05 parts by weight of a 10 wt % aqueous aluminum polychloride solution as an aluminum-based aggregating agent was added to the resultant dispersion, and a dispersion operation was continued with Ultra-Turrax T50.

| | |
|---|---|
| Crystalline resin particle dispersion 1 | 50 parts by weight |
| Non-crystalline resin particle dispersion 1 | 230 parts by weight |
| Coloring agent particle dispersion 1 | 25 parts by weight |
| Release agent particle dispersion 1 | 45 parts by weight |

Then, a stirrer and a mantle heater were installed, and the dispersion was heated to about 50° C. at a rate of about 0.5° C./min while the rotational speed of the stirrer was controlled to sufficiently stir the slurry and then maintained at about 50° C. for about 15 minutes. Then, a particle diameter was measured with Coulter Multisizer II (aperture diameter: about 50 μm, manufactured by Beckmann-Coulter Inc.) at intervals of 10 minutes under heating-up at about 0.05° C./min. When the volume-average particle diameter was about 5.7 μm, 105 parts by weight of the noncrystalline resin particle dispersion 1 (additive resin) was poured over 5 minutes. After the dispersion was maintained for 30 minutes after pouring, 0.15 parts by weight of a chelating agent (Chelest 4K-50, manufactured by Chelest Corp.) was added. Then, pH was adjusted to about 7.8 with a 5% aqueous sodium hydroxide solution, and the dispersion was maintained for 15 minutes. Then, the temperature was increased to about 92° C. at a heating rate of about 1° C./min while pH was adjusted to about 7.8 at intervals of about 5° C., and the dispersion was maintained at about 92° C. As a result of observation of the particle shape and surface properties with an optical microscope and a scanning electron microscope (FE-SEM) at intervals of about 30 minutes, spherical particles were observed after the passage of 3 hours. Therefore, the temperature was increased to about 35° C. at about 1° C./min to solidify the particles.

Then, the reaction product was filtered off, sufficiently washed with ion-exchanged water, and then dried with a vacuum dryer to obtain toner particles 1 having a volume-average particle diameter of about 6.5 μm.

The resultant toner was measured with Coulter Counter TA-II (Coulter Inc.) to determine the volume-average particle diameter D₅₀, volume-average particle size distribution index GSDv, and number-average particle size distribution index GSDp of the toner. As a result, D₅₀ was about 6.5 μm, GSDv was about 1.21, and GSDp was about 1.24.

Then, 1 part by weight of colloidal silica (manufactured by Nippon Aerosil Co., Ltd., R972) was added to 100 parts by weight of the toner particles, and mixed and blended using a Henschel mixer to produce a toner 1 containing silica externally added.

### (Method for Measuring Molecular Weight and Molecular Weight Distribution of Resin)

The molecular weight and molecular weight distribution of a resin are measured by a known method, but generally measured by gel permeation chromatography (abbreviated as “GPC” hereinafter).

Specifically, the molecular weight and molecular weight distribution of a resin were measured under the following conditions: HCL-8120 GPC, SC-8020 manufactured by Tosoh Corp. was used as a GPC apparatus, TSK gel, Super HN-H (6.0 mm ID×15 cm×2) was used as a column, and THF (tetrahydrofuran) for chromatography manufactured by Wako Pure Chemical Industries) was used as an eluent. The experimental conditions included a sample concentration of about 0.5%, a flow rate of about 0.6 ml/min, a sample injection amount of about 10 μl, and a measurement temperature of about 40° C. A calibration curve was formed using 10 samples of A-500, F-1, F-10, F-80, F-380, A-2500, F-4, F-40, F-128, and F-700. In sample analysis, a data collection interval was about 300 ms.

### (Method for Measuring Viscoelasticity of Toner)

The storage modulus G′ and loss modulus G″ are measured, for example, using a rotary plate rheometer (TA Instruments Co., Ltd., ARES). In this example, temperature rise measurement was performed at a frequency of about 1 Hz using a rheometer (Rheometric Scientific Inc., ARES Rheometer) and parallel plates having a diameter of about 8 mm. A sample was set at about 140° C. with a zero-point adjustment temperature of about 90° C. and an inter-plate gap of about 3.5 mm, cooled to room temperature, and then heated at a heating rate of about 1° C./min from a measurement start temperature about 30° C. with an initial measurement strain 0.01% to measure storage modulus G′, loss modulus G″, and tan δ at intervals of about 1° C. during heating. During temperature rising, the strain was controlled up to the maximum strain of about 20% so that the detected torque was about 10 gcm. The measurement was stopped when the detected torque was below the lower limit of measurement guaranteed values.

As a result of measurement of the toner 1 by the above-described method, the storage modulus G′ was about 9.5×10³ dN/m², and tan δ was about 0.32.

### <Preparation of Toner (Preparation of Toner 2)>

Toner particles 2 were produced by the same method as for the toner particles 1 except that the noncrystalline polyester resin (2) was used in place of the noncrystalline polyester resin (1), and the amount of the chelating agent added was changed to about 0.14 part by weight. The toner particles 2 showed D₅₀ of about 6.6 μm, GSDv of about 1.21, and GSDp of about 1.22.

Then, 1 part by weight of colloidal silica (manufactured by Nippon Aerosil Co., Ltd., R972) was added to 100 parts by weight of the toner particles, and mixed and blended using a Henschel mixer to produce a toner 2 containing silica externally added.

The storage modulus G′ of the toner 2 was about 8.5×10³ dN/m², and tan δ was about 0.52.

### <Preparation of Toner (Preparation of Toner 3)>

Toner particles 3 were produced by the same method as for the toner particles 1 except that the noncrystalline polyester resin (2) was used in place of the noncrystalline polyester resin (1), and the amount of the chelating agent added was changed to about 0.18 part by weight. The toner particles 3 showed D₅₀ of about 6.3 μm, GSDv of about 1.22, and GSDp of about 1.25.

Then, 1 part by weight of colloidal silica (manufactured by Nippon Aerosil Co., Ltd.) was added to 100 parts by weight of the toner particles, and mixed and blended using a Henschel mixer to produce toner 3 containing silica externally added.

The storage modulus G′ of the toner 3 was about 7.3×10³ dN/m², and tan δ was about 0.38.

Next, production of fixing rolls of examples and comparative examples is described.

### Example 1

### <Production of Fixing Roll>

An aluminum pipe (metal cylinder) having a diameter φ of about 50 mm and a wall thickness of about 2.0 mm was used as a metallic core, and the surface of the metallic core was plated with nickel by electroless plating using an electroless nickel plating bath (trade name “Kaniboron”, manufactured by Japan Kanigen Co., Ltd.) containing about 0.3 g/L of dimethylaminoboron and about 30 g/L of sodium hypophosphite as a reducing agent to form a plating film having a thickness of about 10 μm on the surface of the metallic core. The electroless nickel plating bath contained about 25 g/L of nickel sulfate as a nickel source.

In the electroless plating, the plating bath was adjusted to about pH 5.5 and heated to about 85° C. After the completion of reaction, the metal cylinder having the electroless plating layer formed thereon was taken out from the plating bath, washed with water, and then dried to produce a fixing roll 1.

Detachability and back staining were evaluated by an evaluation method described below using the fixing roll 1 as a fixing roll and the toner 1 as a toner.

### Example 2

Detachability and back staining were evaluated by an evaluation method described below using the fixing roll 1 as a fixing roll and the toner 2 as a toner.

### Example 3

Detachability and back staining were evaluated by an evaluation method described below using the fixing roll 1 as a fixing roll and the toner 3 as a toner.

### Comparative Example 1

A fixing roll 2 was produced by the same method as in Example 1 except that a plating bath not containing dimethylaminoboron was used.

Detachability and back staining were evaluated by an evaluation method described below using the fixing roll 2 as a fixing roll and the toner 1 as a toner.

### Comparative Example 2

A fixing roll 3 was produced by the same method as in Example 1 except that a plating bath not containing sodium hypophosphite was used.

Detachability and back staining were evaluated by an evaluation method described below using the fixing roll 3 as a fixing roll and the toner 1 as a toner.

### Comparative Example 3

A fixing roll 4 was produced by the same method as in Example 1 except that an electroless nickel plating layer was not provided.

Detachability and back staining were evaluated by an evaluation method described below using the fixing roll 4 as a fixing roll and the toner 1 as a toner.

### (Incorporation in Fixing Device)

The fixing roll of each of Example 1 and Comparative Examples 1 and 2 was provided a roll-type fixing device shown in FIG. 2. The nip width was set to about 8.5 mm.

### (Evaluation)

A toner image with an applied toner amount controlled to about 12.5 g/m² was fixed at a process speed of about 220 mm/sec and a fixing roll temperature of about 180° C. using, as an image forming apparatus, a remodeled apparatus in which a fixing device of Docu Centre Color 500 (manufactured by Fuji Xerox Co., Ltd.) was changed to each of the above-described fixing devices. In forming an image, ST paper (manufactured by Fuji Xerox Co., Ltd., A3, basis weight 54 g/m²) was used as a recording medium (paper).

As evaluation toner images, an image and a character image were formed as follows: A solid image of 20×20 mm was formed at a portion about 15 mm separate from the leading edge of the paper in a direction opposite to the paper transport direction and about 150 mm separate vertically from the left end in the paper transport direction.

Under the above-described conditions, images were continuously formed on 100,000 sheets. In samples after imaging on 50,000 sheets, 1,000 sheet samples were randomly selected and subjected to evaluation of detachability and back staining.

### <Detachability>

Detachability was evaluated as follows:

Offset and separation claw marks (image defect) on ST paper on which a solid image was fixed were visually observed and evaluated on the basis of the following criteria:

Double circle: Separation was particularly good, and neither offset nor separation claw marks occurred.

Circle: No offset occurred and slight gloss variation occurred at a level recognizable by close observation, without resulting in separation claw marks (image defect).

Triangle: No offset occurred and slight image defect occurred, but separation was possible using a separation claw without causing a practical problem.

Cross: Separation in fixing was insufficient and offset occurred, causing a practical problem.

The results are shown in Table 1 below.

### <Back Staining>

Back staining was evaluated as follows:

The back side of ST paper on which a solid image was fixed was visually observed. The number of sample sheets on which back staining was observed was counted to determine a rate of occurrence of back staining according to the following equation:

Rate of occurrence of back staining (%)=(number of sheets with back staining)/(total, number of sheets randomly selected=1000)×100

The evaluation criteria were as follows:

Double circle: Occurrence rate of back staining of 0%

Circle: Occurrence rate of back staining of less than 2%

Triangle: Occurrence rate of back staining of 2% or more and less than 5%

Cross: Occurrence rate of back staining of 5% or more

The results are shown in Table 1 below.

TABLE 1

| | Toner | | | | Surface layer | | | |
|---|---|---|---|---|---|---|---|---|
| | D₅₀ | | G′ | | | Thickness | | Back |
| | (μm) | GSDᵥ | (dN/m²) | Tan δ | Reducing agent | (μm) | Detachability | staining |
| Example 1 | 6.5 | 1.21 | 9.5 × 10³ | 0.32 | Dimethylaminoboron | 10 | Double | Double |
| | | | | | Sodium | | circle | circle |
| | | | | | hypophosphite | | | |
| Example 2 | 6.6 | 1.21 | 8.5 × 10³ | 0.52 | Dimethylaminoboron | 10 | Double | Circle |
| | | | | | Sodium | | circle | |
| | | | | | hypophosphite | | | |
| Example 3 | 6.3 | 1.22 | 7.3 × 10³ | 0.38 | Dimethylaminoboron | 10 | Circle | Circle |
| | | | | | Sodium | | | |
| | | | | | hypophosphite | | | |
| Comparative | 6.5 | 1.21 | 9.5 × 10³ | 0.32 | Sodium | 15 | Double | Triangle |
| Example 1 | | | | | hypophosphite | | circle | |
| Comparative | 6.5 | 1.21 | 9.5 × 10³ | 0.32 | Dimethylaminoboron | 10 | Double | Triangle |
| Example 2 | | | | | | | circle | |
| Comparative | 6.5 | 1.21 | 9.5 × 10³ | 0.32 | — | — | Circle | Cross |
| Example 3 | | | | | | | | |

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A fixing device configured to fix a toner image formed on a recording medium, the fixing device comprising:
a fixing roll;
a separation claw in contact with the fixing roll; and
a pressure member disposed to face the fixing roll,
wherein the fixing roll includes a metallic core and a surface layer formed on the metallic core; and
the surface layer is an electroless nickel plating layer containing a boron compound and a phosphorus compound.

2. The fixing device according to claim 1, wherein a storage modulus G′ (140° C.) of the toner at about 140° C. and a frequency of about 1 Hz is about 8.0×10³ dN/m² or more and about 2.0×10⁴ dN/m² or less, and a dynamic loss tangent (tan δ=G″/G′) that is a ratio of loss modulus G″ to storage modulus G′ at a temperature of about 140° C. is about 0.2 or more and about 0.4 or less.

3. The fixing device according to claim 1, wherein the toner includes a binder resin containing a polyester resin.

4. The fixing device according to claim 3, wherein the ratio of the polyester resin in the binder resin is about 50% by weight or more.

5. The fixing device according to claim 3, wherein the polyester resin contains a crystalline polyester resin.

6. The fixing device according to claim 5, wherein the melting point of the crystalline polyester resin is about 45° C. to 110° C.

7. The fixing device according to claim 5, wherein the acid value of the crystalline polyester resin is about 1 to 30 mgKOH/g.

8. The fixing device according to claim 1, wherein the toner includes paraffin wax.

9. The fixing device according to claim 1, wherein the toner has a volume-average particle diameter D₅₀ of about 4.0 to 10.0 μm.

10. The fixing device according to claim 1, wherein a ratio (D84v/D16v)^{1/2} (GSDv: volume-average particle size distribution index) of a diameter (D84v) at an accumulation of about 84% to a diameter (D16v) at an accumulation of about 16% of the toner is about 1.30 or less.

11. The fixing device according to claim 1, wherein a ratio (D84p/D16p)^{1/2} (GSDp: number-average particle size distribution index) of the toner is about 1.40 or less.

12. The fixing device according to claim 1, wherein the metallic core includes at least one selected from stainless steel, iron, and aluminum.

13. The fixing device according to claim 1, wherein the born compound is dimethylaminoboron.

14. The fixing device according to claim 1, wherein the phosphorus compound is sodium hypophosphite.

15. An image forming apparatus comprising:
an image carrier;
a charging unit that charges the image carrier;
an exposure unit that exposes the charged image carrier to form an electrostatic latent image on the image carrier;
a developing unit that develops the electrostatic latent image with a developer containing a toner to form a toner image;
a transfer unit that transfers the toner image to a recording medium; and
a fixing unit that fixes the toner image to the recording medium,
wherein the fixing unit is the fixing device according to claim 1.
